(19) United States
(12) Patent Application Publication
(10) Pub. No.: US 2014/0253531 A1
(43) Pub. Date: Sep. 11, 2014

(54) GATE DRIVER AND DISPLAY DRIVER CIRCUIT

(71) Applicant: Samsung Electronics Co., Ltd., Suwon-Si (KR)

(72) Inventors: Jae-Bum LEE, Gwangmyeong-Si (KR); Hyun-Sang PARK, Seongnam-Si (KR)

(73) Assignee: SAMSUNG ELECTRONICS CO., LTD., Suwon-Si (KR)

(21) Appl. No.: 14/095,055

(22) Filed: Dec. 3, 2013

(30) Foreign Application Priority Data
Mar. 6, 2013 (KR) 10-2013-0023942

(51) Int. Cl. G09G 3/36

(52) U.S. Cl. CPC G09G 3/3677
USPC 345/212; 345/98

(57) ABSTRACT

A gate driver for driving gate lines of a display panel includes a scan signal generator configured to generate a scan signal for selecting one of the gate lines, and an output circuit. The output circuit is configured to receive a gate-on voltage, a first gate-off voltage, and a second gate-off voltage. The gate-on voltage is a voltage that turns on at least one transistor connected to the selected gate line, and the first gate-off voltage and the second gate-off voltage are voltages that turn off the at least one transistor connected to the selected gate line. The output circuit is configured to output the gate-on voltage to the selected gate line in response to a first state of the scan signal, and sequentially output the first gate-off voltage and the second gate-off voltage to the selected gate line in response to a second state of the scan signal.

### CROSS-REFERENCE TO RELATED APPLICATIONS

This application claims the benefit of Korean Patent Application No. 10-2013-0023942, filed on Mar. 6, 2013, in the Korean Intellectual Property Office, the disclosure of which is incorporated herein in its entirety by reference.

### BACKGROUND

The inventive concepts relate to a display driver circuit, and more particularly, to a gate driver that drives a display panel.

Flat panel display devices are used in electronic devices, such as televisions, notebooks, monitors, mobile terminals, and the like, for displaying images. Examples of flat panel display devices include liquid crystal display (LCD) devices and organic light emitting devices. A flat panel display device includes a panel for forming images, the panel including a plurality of pixels. Images are formed on the panel as the plurality of pixels are driven by data signals provided by a display driver circuit. A frame frequency of the flat panel display device has increased in order to form three-dimensional images or improve video quality, and a load of a panel which a display driver circuit drives has increased as the size and resolution of the panel have increased.

### SUMMARY

At least one embodiment of the inventive concepts provides a gate driver for driving a gate line of a panel quickly.

At least one embodiment of the inventive concepts also provides a display driver circuit for driving a high resolution display panel.

According to at least one example embodiment, a gate driver for driving gate lines of a display panel includes a scan signal generator configured to generate a scan signal for selecting one of the gate lines, and an output circuit. The output circuit is configured to receive a gate-on voltage, a first gate-off voltage, and a second gate-off voltage. The gate-on voltage is a voltage that turns on at least one switching device connected to the selected gate line, and the first gate-off voltage and the second gate-off voltage are voltages that turn off the at least one switching device connected to the selected gate line. The output circuit is also configured to output the gate-on voltage to the selected gate line in response to a first state of the scan signal, and sequentially output the first gate-off voltage and the second gate-off voltage to the selected gate line in response to a second state of the scan signal.

According to at least one example embodiment, the output circuit is configured to output the gate-on voltage in a gate ‘on’ period of the scan signal, output the first gate-off voltage in a first period of a gate ‘off’ period of the scan signal, and output the second gate-off voltage in a second period of the gate ‘off’ period after the first period.

According to at least one example embodiment, the first gate-off voltage is a voltage modulated to periodically fall from a first low level equal to a voltage level of the second gate-off voltage to a second low level less than the first low level.

According to at least one example embodiment, the gate-on voltage is a voltage modulated to periodically fall from a first high level to a second high level, a fall period of the first gate-off voltage being equal to a fall period of the gate-on voltage.

According to at least one example embodiment, a difference between a voltage level of the gate-on voltage and a voltage level of the first gate-off voltage is constant.

According to at least one example embodiment, the first gate-off voltage has a first low level that is constant, and the second gate-off voltage has a second low level that is constant and greater than the first low level.

According to at least one example embodiment, the output circuit comprises a pull-up portion and a pull-down portion. The pull-up portion is connected to the gate-on voltage and configured to output the gate-on voltage to an output terminal if the scan signal is in the first state. The pull-down portion is connected to the first gate-off voltage and the second gate-off voltage and configured to sequentially output the first gate-off voltage and the second gate-off voltage to the output terminal if the scan signal is in the second state.

According to at least one example embodiment, the gate driver further includes a control signal generator configured to generate a plurality of control signals based on the scan signal, the plurality of control signals controlling the output circuit.

According to at least one example embodiment, the pull-down portion includes a transistor having a source terminal connected to the first gate-off voltage, a drain terminal connected to the output terminal, and a gate terminal connected to a control signal. The transistor is configured to perform a switching operation in response to the control signal to output the first gate-off voltage. The pull-down portion also includes a pull-down resistor connected between the second gate-off voltage and the output terminal.

According to at least one example embodiment, the pull-down portion includes a first transistor having a source terminal connected to the first gate-off voltage, a drain terminal connected to the output terminal, and a gate terminal connected to a first control signal. The first transistor is configured to perform a switching operation in response to the first control signal to output the first gate-off voltage. The pull-down portion includes a second transistor having a source terminal connected to the second gate-off voltage, a drain terminal connected to the output terminal, and a gate terminal connected to a second control signal. The second transistor is configured to perform a switching operation in response to the second control signal to output the second gate-off voltage.

According to at least one example embodiment, the gate driver drives ‘n’ number of gate lines and the scan signal generator generates ‘n’ number of scan signals, wherein ‘n’ is a natural number.

According to at least one example embodiment, a display driver circuit includes a voltage generator configured to generate a plurality of power supply voltages by using an external power supply, a source driver configured to apply data signals to a display panel, and a gate driver. The gate driver is configured to receive a gate-on voltage, a first gate-off voltage, and a second gate-off voltage from the voltage generator. The gate-on voltage is a voltage that turns on at least one transistor connected to the selected gate line, and the first gate-off voltage and the second gate-off voltage are voltages that turn off the at least one transistor connected to the selected gate line. The gate driver is configured to sequentially output the gate-on voltage, the first gate-off voltage, and the second gate-off voltage as a gate signal based on a scan signal of a corresponding gate line.

According to at least one example embodiment, the gate driver is configured to output the gate-on voltage in a gate ‘on’ period, output the first gate-off voltage in a first period of a gate ‘off’ period, and output the second gate-off voltage in a second period of the gate ‘off’ period after the first period.

According to at least one example embodiment, in the first period, a voltage level of the first gate-off voltage is less than a voltage level of the second gate-off voltage.

According to at least one example embodiment, the gate driver is connected to both sides of the display panel.

According to at least one example embodiment, a gate driver for a display panel includes a scan signal generator configured to generate at least one scan signal for selecting at least one gate line of the display panel, and at least one output circuit. The at least one output circuit is configured to sequentially output at least first, second, and third voltages to the selected at least one gate line based on the at least one scan signal, the first voltage being greater than the second and third voltages, the second voltage being less than the third voltage.

According to at least one example embodiment, the first voltage corresponds to a gate ‘on’ voltage, and the second and third voltages correspond to first and second gate ‘off’ voltages, respectively. The gate ‘on’ voltage is a voltage that turns on at least one switching device connected to the selected at least one gate line, and the first gate ‘off’ voltage and the second gate ‘off’ voltage are voltages that turn off the at least one switching device connected to the selected at least one gate line.

According to at least one example embodiment, an output duration of the second voltage is less than an output duration of the third voltage.

According to at least one example embodiment, the at least one output circuit includes a pull-up circuit and a pull-down circuit. The pull-up circuit is configured to output the first voltage to the selected at least one gate line if the at least one scan signal has a first state. The pull-down circuit is configured to sequentially output the second and third voltages to the selected at least one gate line if the at least one scan signal switches from the first state to a second state.

According to at least one example embodiment, the first voltage is a modulated voltage that periodically has a fall period in which the first voltage falls from a first high level to a second high level, the second voltage is a modulated voltage that periodically has a fall period in which the second voltage falls from a first low level to a second low level, and the third voltage is a constant voltage.

### BRIEF DESCRIPTION OF THE DRAWINGS

Exemplary embodiments of the inventive concept will be more clearly understood from the following detailed description taken in conjunction with the accompanying drawings in which:

FIG. 1 is an example block diagram of a display device according to at least one example embodiment of the inventive concepts;

FIG. 2 is an example equivalent circuit diagram of each pixel illustrated in FIG. 1;

FIG. 3 is an example schematic block diagram of a gate driver illustrated in FIG. 1;

FIG. 4 is an example block diagram minutely illustrating a gate driver illustrated in FIG. 1;

FIG. 5 is an example timing diagram of a gate driver of FIG. 4;

FIG. 6 is an example equivalent circuit of a gate line of a display panel illustrated in FIG. 1;

FIG. 7 is an example timing diagram illustrating a gate signal and gate voltages at two points on the gate line of FIG. 6;

FIG. 8 is an example circuit diagram illustrating an implementation of the gate driver of FIG. 4;

FIG. 9 is an example timing diagram illustrating an operation timing of a gate driver of FIG. 8;

FIG. 10 is an example timing diagram illustrating another operation timing of the gate driver of FIG. 8;

FIG. 11 is an example circuit diagram illustrating another implementation of the gate driver of FIG. 4;

FIG. 12 is an example timing diagram illustrating an operation timing of a gate driver of FIG. 11;

FIG. 13 is an example diagram illustrating an implementation of the display device of FIG. 1; and

FIG. 14 is an example diagram illustrating another implementation of the display device of FIG. 1.

### DETAILED DESCRIPTION OF EXAMPLE EMBODIMENTS

Example embodiments will be understood more readily by reference to the following detailed description and the accompanying drawings. The example embodiments may, however, be embodied in many different forms and should not be construed as being limited to those set forth herein. Rather, these example embodiments are provided so that this disclosure will be thorough and complete. In at least some example embodiments, well-known device structures and well-known technologies will not be specifically described in order to avoid ambiguous interpretation.

It will be understood that when an element is referred to as being “connected to” or “coupled to” another element, it can be directly on, connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third, etc., may be used herein to describe various elements, components and/or sections, these elements, components and/or sections should not be limited by these terms. These terms are only used to distinguish one element, component or section from another element, component or section. Thus, a first element, component or section discussed below could be termed a second element, component or section without departing from the teachings of the example embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes,” and/or “including” when used in this specification, specify the presence of stated components, steps, operations, and/or elements, but do not preclude the presence or addition of one or more other components, steps, operations, elements, and/or groups thereof.

Unless otherwise defined, all terms (including technical and scientific terms) used herein have the same meaning as commonly understood by one of ordinary skill in the art to which these example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms, such as “below”, “beneath”, “lower”, “above”, “upper”, and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

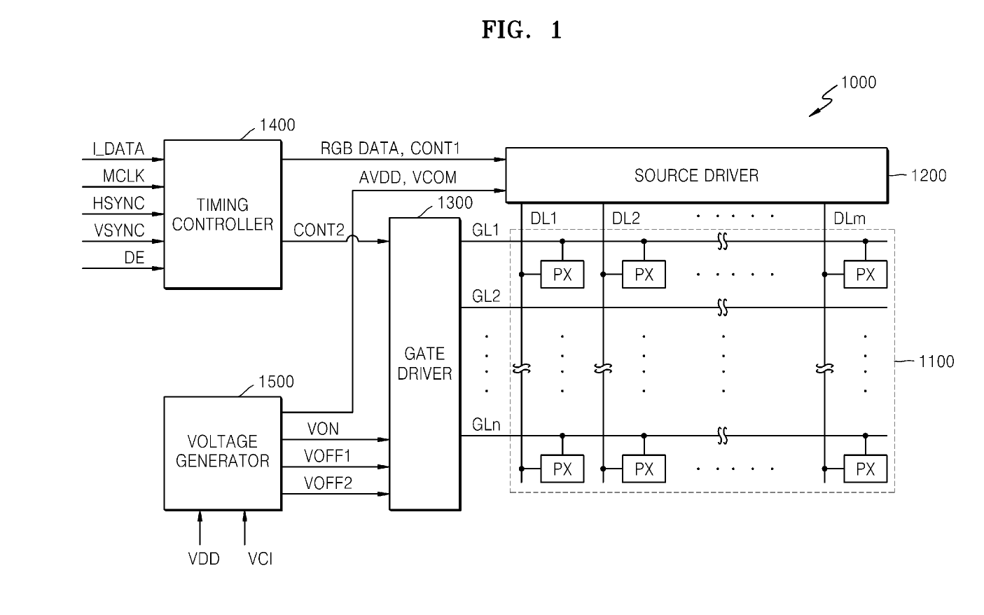

FIG. 1 is a schematic block diagram of a display device 1000 according to at least one example embodiment of the inventive concepts. Referring to FIG. 1, the display device 1000 includes a panel 1100 for displaying an image and a driving circuit for driving the panel 1100. The driving circuit may include a source driver 1200 that drives a plurality of data lines DL1 to DLm of the panel 1100, a gate driver 1300 that drives a plurality of gate lines GL1 to GLn of the panel 1100, a timing controller 1400 that generates various timing signals CONT1 and CONT2 for controlling the source driver 1200 and the gate driver 1300 and data RGB DATA, and a voltage generator 1500 that generates various voltages VON, VOFF, AVDD, and VCOM for driving the display device 1000.

The display device 1000 may be any flat panel display device such as a liquid crystal display (LCD), an organic electro luminance (EL) display, a plasma display panel (PDP), and the like. For convenience of explanation, it is assumed below that the display device 1000 is an LCD.

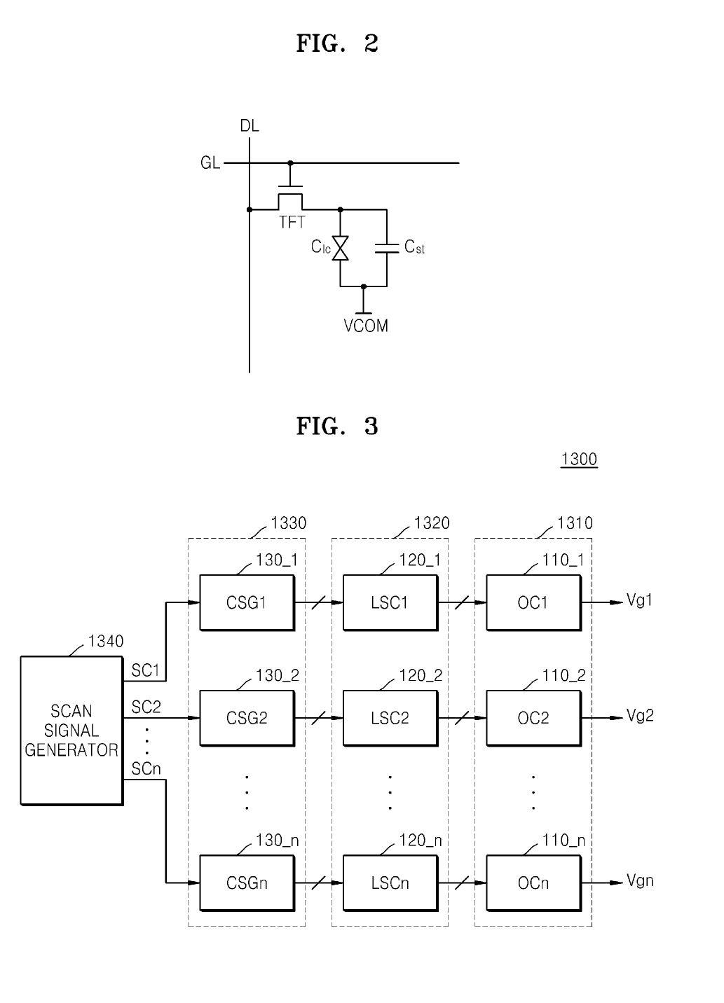

The panel 1100 includes the plurality of gate lines GL1 to GLn, the plurality of data lines DL1 to DLm intersecting the plurality of gate lines GL1 to GLn, and a plurality of pixels PX disposed at intersections of the plurality of gate lines GL1 to GLn and the plurality of data lines DL1 to DLm. As illustrated in FIG. 2, the display device 1000 may be an LCD including thin film transistors (TFTs). Each of the pixels PX includes a TFT having a gate electrode and a source electrode that are connected to a gate line GL and a data line DL, respectively. Each of the pixels PX also includes a liquid crystal capacitor C_{lc} and a storage capacitor Cₛₜ that are connected to a drain electrode of the TFT. In such a pixel structure, when the gate line GL is selected, the TFT of a pixel connected to the selected gate line GL is turned on, and then a data signal containing pixel information is supplied to the data line DL from the source driver 1200. The data signal is supplied to the liquid crystal capacitor C_{I}, and the storage capacitor Cₛₜ via the TFT of the connected pixel, and the liquid crystal capacitor C_{lc} and the storage capacitor Cₛₜ are then driven to display an image.

The timing controller 1400 receives external data I_DATA, a horizontal synchronization signal H_SYNC, a vertical synchronization signal V_SYNC, a clock signal MCLK, and a data enable signal DE from an external device (not shown). The timing controller 1400 generates pixel data RGB DATA, the format of which is in accordance with interface specifications with the source driver 1200, and supplies the pixel data RGB DATA to the source driver 1200. Also, the timing controller 1400 generates various control signals for controlling timing between operations of the source driver 1200 and the gate driver 1300. For example, timing controller 1400 outputs at least one data control signal CONT1 to the source driver 1200, and outputs at least one gate control signal CONT2 to the gate driver 1300.

The voltage generator 1500 receives power supply voltages VDD and VCI from the outside, and generates various voltages for operating the display device 1000. For example, the voltage generator 1500 generates a gate-on voltage VON, a first gate-off voltage VOFF1, and a second gate-off voltage VOFF2. The voltage generator 1500 applies the gate-on voltage VON, the first gate-off voltage VOFF1, and the second gate-off voltage VOFF2 to the gate driver 1300, and generates an analog power supply voltage AVDD and a common voltage VCOM. The voltage generator 1500 applies the analog power supply voltage AVDD and the common voltage VCOM to the source driver 1200.

The source driver 1200 receives the data control signal CONT1 and the pixel data RGB DATA from the timing controller 1400, converts the pixel data RGB DATA into a data signal having a voltage or current form in response to the data control signal CONT1, and supplies the data signal to the pixels PX through the data lines DL1 to DLm.

The gate driver 1300 receives the gate control signal CONT2 from the timing controller 1400 and generates a gate signal. The gate driver 1300 may supply the generated gate signal to the pixels PX through the gate lines GL1 to GLn. Pixels PX of each row may be sequentially selected according to the gate signal, and the gate signal may be provided to the selected pixels.

FIG. 3 is a block diagram illustrating an implementation example of the gate driver 1300 illustrated in FIG. 1. Referring to FIG. 3, the gate driver 1300 may include a scan signal generator 1340, a control signal generator block 1330, a level shifter block 1320, and an output circuit block 1310.

The gate driver 1300 outputs “n” number of gate signals Vg1 to Vgn corresponding to “n” number of gate lines through “n” number of channels. Each of the n gate signals Vg1 to Vgn is provided to drive pixels of one gate line of the panel 1100. One frame is implemented in the panel 1100 by outputting the n gate signals Vg1 to Vgn to the n gate lines.

The scan signal generator 1340 generates scan signals SC1, SC2, . . . , SCn that are pulse signals for selecting (e.g., sequentially selecting) and activating (e.g., sequentially activating) the gate lines of the panel 1100 in response to the gate control signal CONT2 which is received from the outside (for example, the timing controller 1400 of FIG. 1). The scan signal generator 1340 may be implemented with a plurality of shift registers. For example, the scan signal generator 1340 may include a number of shift registers corresponding to the number of channels of the gate driver 1300. Each shift register may generate a scan signal in response to a clock signal and an output of a previous shift register. Thus, the scan signals SC1, SC2, . . . , SCn may be generated (e.g., sequentially generated). However, the inventive concepts are not limited thereto and the scan signal generator 1340 may be implemented with various circuits. For example, the scan signal generator 1340 may be a decoder that decodes a signal received from the outside to generate the scan signals SC1, SC2, . . . , SCn.

The control signal generator block 1330 generates control signals for controlling the output circuit block 1310 based on the scan signals SC1, SC2, . . . , SCn provided from the scan signal generator 1340. The control signal generator block 1330 may include a plurality of control signal generation circuits 130_1, 130_2, . . . , 130_{—}n. Each of the control signal generation circuits 130_1, 130_, . . . , 130_{—}n may receive a corresponding scan signal and then may generate a plurality of control signals for controlling the output circuit portion 1310.

The level shifter block 1320 converts the voltage levels of the control signals output from the control signal generator block 1330 to voltage levels for controlling output circuits 110_1, 110_2, . . . , 110_{—}n of the output circuit block 1310. The control signals output from the control signal generator block 1330 are logic signals, and thus, the voltage levels of the control signals may be relatively low. However, the output circuits 110_1, 110_2, . . . , 110_{—}n of the output circuit block 1310 may be circuits that operate by signals each having a relatively high voltage level (for example, a positive high voltage level or a negative high voltage level) compared to the control signals. In order to normally operate the output circuit block 1310, the level shifter block 1320 may convert the voltage level of each of the control signals to a voltage level for controlling the output circuit block 1310, and then may provide the voltage level-converted control signals to the output circuit block 1310.

The output circuit block 1310 generates the gate signals Vg1 to Vgn for driving the gate lines of the panel 1100. The output circuit portion 1310 includes the plurality of output circuits 110_1, 110_2, . . . , 110_{—}n, and each of the gate signals Vg1 to Vgn output from the output circuits 110_1, 110_2, . . . , 110_{—}n is provided to a corresponding gate line. The output circuits 110_1, 110_2, . . . , 110_{—}n may generate the gate signals Vg1 to Vgn based on the gate-on voltage VON, the first gate-off voltage VOFF1, and the second gate-off voltage VOFF2, which are provided from the voltage generator 1500 illustrated in FIG. 1, to output the gate signals Vg1 to Vgn.

The control signal generator block 1330 may include a number of the control signal generation circuits 130_1, 130_2, . . . , 130_{—}n corresponding to the number of channels of the gate driver 1300. The level shifter 1320 may include a number of level shift circuits 120_1, 120_2, . . . , 120_{—}n corresponding to the number of channels of the gate driver 1300. In addition, the output circuit block 1310 may include a number of the output circuits 110_1, 110_2, . . . , 110_{—}n corresponding to the number of channels of the gate driver 1300. One control signal generation circuit, one level shift circuit, and one output circuit, which correspond to each other, may constitute one channel for generating one gate signal. Each channel may operate in response to a corresponding scan signal. For example, the first control signal generation circuit 130_1, the first level shift circuit 120_1, and the first output circuit 110_1 may constitute a first channel that generates the first gate signal Vg1 in response to the first scan signal SC1. The first control signal generation circuit 130_1 receives the first scan signal SC1 and then generates a plurality of control signals. The first level shift circuit 120_1 converts the voltage levels of the plurality of control signals received from the first control signal generation circuit 130_1 to voltage levels suitable for controlling the first output circuit 110_1 and provides the voltage level-converted control signals to the first output circuit 110_1. The first output circuit 110_1 may output (e.g., sequentially output) the gate-on voltage VON, the first gate-off voltage VOFF1, and the second gate-off voltage VOFF2 as the first gate signal Vg1 based on the voltage level-converted control signals provided from the first level shift circuit 120_1. The other channels may also operate in the same manner as the first channel.

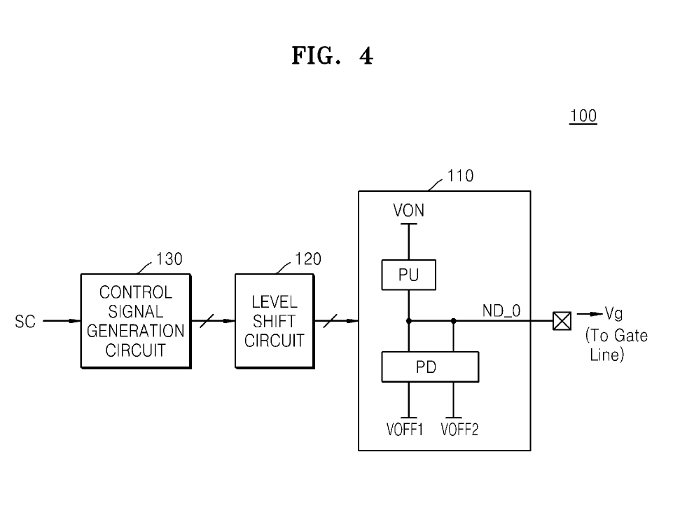

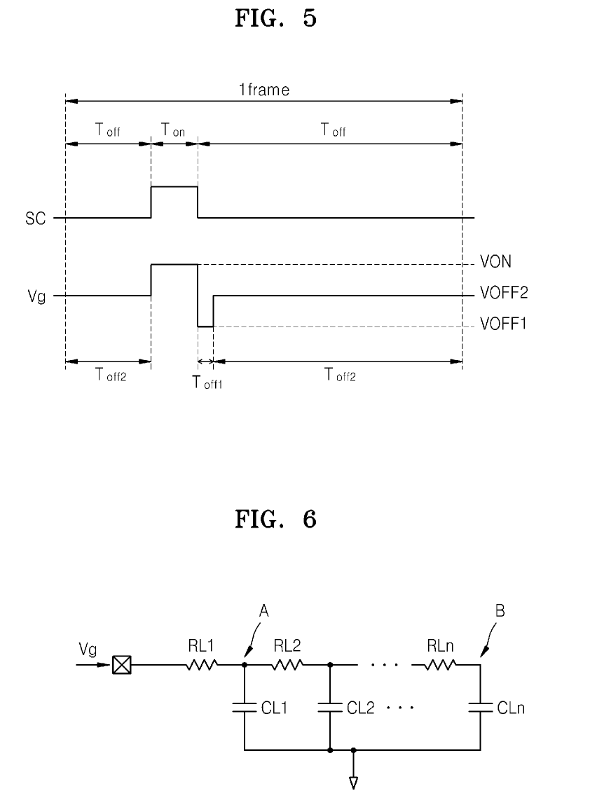

An operation of a gate driver according to at least one example embodiment of the inventive concepts is described in more detail below with reference to FIGS. 4 and 5. FIG. 4 is a block diagram illustrating a gate driver 100 according to at least one example embodiment of the inventive concepts. FIG. 5 is a timing diagram of the gate driver 100 of FIG. 4.

Referring to FIG. 4, the gate driver 100 may include a control signal generation circuit 130, a level shift circuit 120, and an output circuit 110. For convenience of explanation, circuits corresponding to one channel of the gate driver 100 are illustrated in FIG. 4. However, if the gate driver 100 includes “n” number of channels for driving “n” number of gate lines as illustrated in FIG. 3, the gate driver 100 may include “n” number of control signal generation circuits, “n” number of level shift circuits, and “n” number of output circuits.

The control signal generation circuit 130 generates control signals for controlling the output circuit 110 based on a scan signal SC. The level shift circuit 120 converts the voltage levels of the control signals to voltage levels suitable for controlling the output circuit 110. The scan signal generator 1340 of FIG. 3 and the control signal generation circuit 130 may be digital circuits. The digital circuits have a complicated circuit structure and operate at a fast speed. Thus, the control signal generation circuit 130 may operate with supply voltages having a relatively low level. For example, the supply voltages may be a ground voltage VSS and a power supply voltage VDD. However, a gate voltage that is output from the output circuit 110 is a voltage for turning on or turning off a TFT of the pixel PX of FIG. 2, and may have a positive high voltage level and a negative high voltage level compared to VSS and VDD. Accordingly, the output circuit 110 also operates with a relatively high voltage, and thus, a control signal for controlling the output circuit 110 needs to be a signal having a relatively high voltage level. Thus, the level shift circuit 120 converts the voltage levels of the control signals output from the control signal generation circuit 130 to high voltage levels suitable for controlling the output circuit 110, and provides the voltage level-converted control signals to the output circuit 110.

The output circuit 110 receives the gate-on voltage VON, the first gate-off voltage VOFF1, and the second gate-off voltage VOFF2, outputs the gate-on voltage VON to a gate line in response to a first state of the scan signal SC, and outputs (e.g., sequentially outputs) the first gate-off voltage VOFF1 and the second gate-off voltage VOFF2 to the gate line in response to a second state of the scan signal SC. The output circuit 110 may include a pull-up portion PU and a pull-down portion PD. The pull-up portion PU is connected to the gate-on voltage VON, and outputs the gate-on voltage VON to an output terminal VD_O when the scan signal SC is in the first state, e.g., has a logic “high” level. The pull-down portion PD is connected to the first gate-off voltage VOFF1 and the second gate-off voltage VOFF2, and outputs (e.g., sequentially outputs) the first gate-off voltage VOFF1 and the second gate-off voltage VOFF2 to the output terminal VD_O when the scan signal SC transitions from the first state to the second state, e.g., a logic “low” level. For example, the first state of the scan signal SC may indicate an ‘on’ period Ton (see FIG. 5) of a gate line, and the second state of the scan signal SC may indicate an ‘off’ period Toff (see FIG. 5) of the gate line. The ‘off’ period Toff of the gate line may be divided into a first period Toff1 and a second period Toff2. The first period Toff1 may be a desired (or alternatively, predetermined) period of the ‘off’ period Toff after the ‘on’ period Ton of the gate line. The second period Toff2 may be a period from the end of the first ‘off’ period Toff1 until the next start of an ‘on’ period Ton of the gate line. As illustrated in FIG. 5, with respect to one frame, the second ‘off’ period Toff2 may be a remaining period other than the first ‘off’ period Toff1 in the ‘off’ period Toff of the gate line. Thus, a period before the ‘on’ period Ton and a period after the first ‘off’ period Toff1 may correspond to the second ‘off’ period Toff2. A driving circuit, i.e., the output circuit 110 may output the gate-on voltage VON as a gate signal Vg during the ‘on’ period Ton of the gate line, may output the first gate-off voltage VOFF1 as the gate signal Vg during the first ‘off’ period Toff1 of the ‘off’ period Toff of the gate line, and may output the second gate-off voltage VOFF2 as the gate signal Vg during the second ‘off’ period Toff2 of the ‘off’ period Toff of the gate line. The gate-on voltage VON may be a positive high voltage, and the first gate-off voltage VOFF1 and the second gate-off voltage VOFF2 may be negative voltages. The second gate-off voltage VOFF2 may have a fixed voltage level suitable for fully turning off a TFT of a pixel connected to the gate line without leakage of current. The voltage level of the first gate-off voltage VOFF1 that is output during the first period Toff1 may be lower than that of the second gate-off voltage VOFF2.

As illustrated in FIG. 5, the first ‘off’ period Toff1 may be short compared to the second ‘off’ period Toff2 (i.e., an output duration of the first gate-off voltage VOFF1 may be less than an output duration of the second gate-off voltage VOFF2). In this manner, after the output circuit 110 outputs the gate-on voltage VON, the output circuit 110 may output the second gate-off voltage VOFF2 after temporarily outputting the first gate-off voltage VOFF1 having a voltage level that is lower than that of the second gate-off voltage VOFF2 when the scan signal SC transitions from the first state to the second state (i.e., when the state of the gate line is changed from the ‘on’ period Ton to the ‘off’ period Toff.

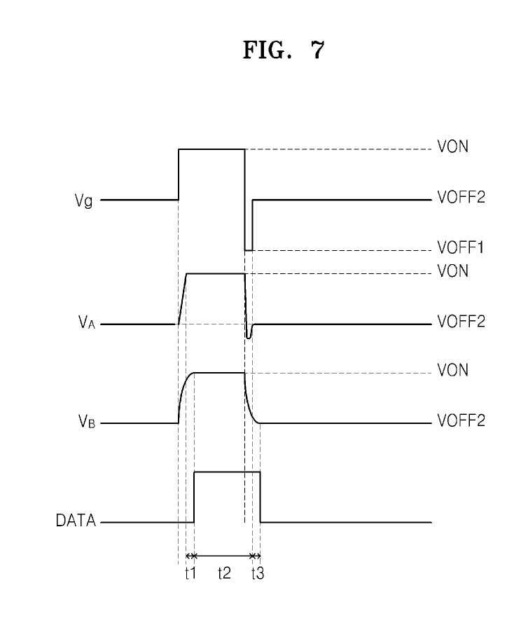

Changes in the gate signal Vg of the gate driver 100 of FIG. 4 and a gate voltage of a gate line are reviewed below with reference to FIGS. 6 and 7. FIG. 6 is an equivalent circuit obtained by modeling a load of a gate line of the display panel 1100 illustrated in FIG. 1. FIG. 7 is an example timing diagram illustrating the gate signal Vg and gate voltages of two points A and B on the gate line of FIG. 6. Referring to FIG. 6, the gate line may be modeled via a circuit in which a plurality of load resistors RL1, RL2, . . . , RLn and a plurality of load capacitors CL1, CL2, . . . , CLn are connected to each other. Parasitic resistances of the gate line may be modeled via the plurality of load resistors RL1, RL2, . . . , RLn, and liquid crystal capacitances of each pixel, storage capacitances, and parasitic capacitances may be modeled via the plurality of load capacitors CL1, CL2, . . . , CLn. Since the gate driver 1300 is disposed at the left side or right side of the display panel 1100 as illustrated in FIG. 1, the gate signal Vg is applied to an end of the gate line. Due to a resistance capacitance (RC) delay, a waveform of a gate voltage VA of a first point A near to one end of the gate line is different from that of a gate voltage VB of a second point B at the other end of the gate line. Since an RC delay is small at the first point A, the waveform of the gate voltage VA of the first point A is similar to the waveform of the gate signal Vg. However, the gate voltage VB of the second point B has a delayed waveform due to an RC delay when the gate signal Vg transitions. A time difference t1 exists between a rising time of the gate voltage VA of the first point A and a rising time of the gate voltage VB of the second point B, and a time difference t3 exists between a fall time of the gate voltage VA and a fall time of the gate voltage VB. In this case, according to at least one example embodiment of the inventive concepts, when the gate signal Vg falls, by temporarily providing the first gate-off voltage VOFF1, the fall time of the gate voltage VA and the fall time of the gate voltage VB may be reduced compared to a case in which the gate signal Vg directly falls from the gate ‘on’ voltage VON to the second gate ‘off’ voltage VOFF2. Thus, the time difference t3 between the fall time of the gate voltage VA and the fall time of the gate voltage VB may also be reduced. The gate signal Vg temporarily falls to the first gate-off voltage VOFF1, but the gate voltage VA and the gate voltage VB do not fall to the voltage level of the first gate-off voltage VOFF1 and have a final voltage level of the second gate-off voltage VOFF2 as shown FIG. 7. Thus, a kickback voltage, which is affected by a difference between a gate voltage of a TFT (see FIG. 2) when the TFT is turned on and the gate voltage of the TFT when the TFT is turned off, does not increase. A period in which data DATA is provided to pixels connected to a gate line is referred to as one horizontal period. The one horizontal period may be a period from a time point when a gate voltage of the gate line reaches the voltage level of the gate-on voltage VON according to the gate signal Vg to a time point when the voltage of the gate line falls to the voltage level of the second gate-off voltage VOFF2. In FIG. 7, the one horizontal period may be a period t2 plus a period t3 (i.e., the time difference t3). In this case, a time period in which data is charged into a pixel is a period (i.e., the period t2) in which the voltage of the gate line maintains the voltage level of the gate-on voltage VON. Thus, the period t3 is a period that is wasted regardless of the charge of the data. The gate driver 100 according to at least one example embodiment of the inventive concepts may substantially increase a time (i.e., the period t2), in which data is charged into a pixel in the one horizontal period, by reducing the period t3 as stated above.

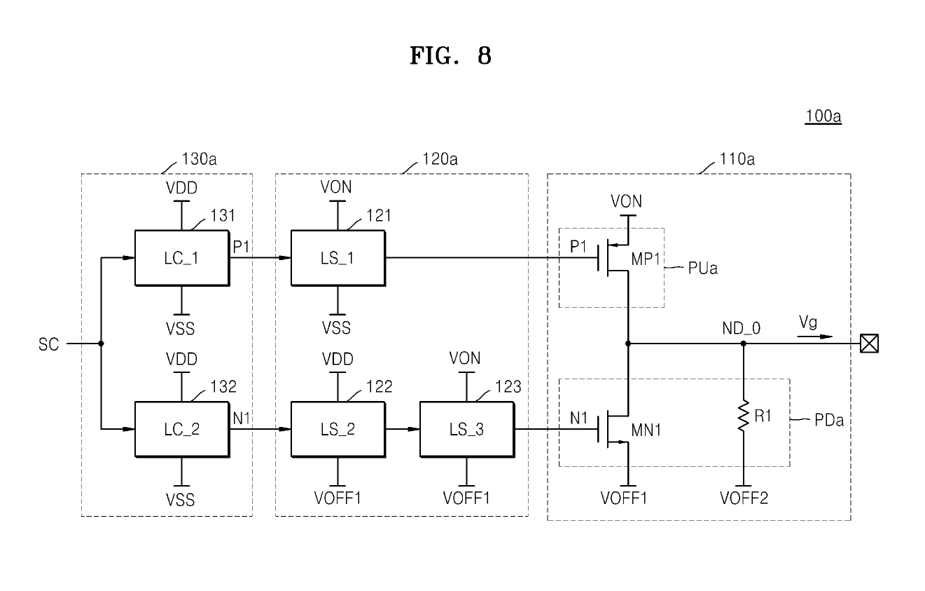

FIG. 8 is an example circuit diagram of a gate driver 100a that is an implementation of the gate driver 100 of FIG. 4. Referring to FIG. 8, a control signal generation circuit 130a may include a first logic circuit 131 that generates a first control signal P1 based on the scan signal SC, and a second logic circuit 132 that generates a second control signal N1 based on the scan signal SC. The first logic circuit 131 and the second logic circuit 132 may receive a ground voltage VSS and a logic power supply voltage VDD to operate.

A level shift circuit 120a may include a first level shifter 121 that shifts the voltage level of the first control signal P1, and second and third level shifters 122 and 123 that shift the voltage level of the second control signal N1. The first level shifter 121 may convert a first state (e.g., the voltage level of logic high) of the first control signal P1 to the voltage level of the gate-on voltage VON. The second level shifter 122 may convert a second state (e.g., the voltage level of logic low) of the second control signal N1 to the voltage level of the second gate-off voltage VOFF2, and the third level shifter 123 may convert the first state (e.g., the voltage level of logic high) of the second control signal N1 to the voltage level of the gate-on voltage VON. An output circuit 110a may include a pull-up portion PUa that operates in response to the first control signal P1 output from the level shift circuit 120a, and a pull-down portion PDa that operates in response to the second control signal N1. The pull-up portion PUa may include a first transistor MP 1 that has a source terminal connected to the gate-on voltage VON, a drain terminal connected to an output terminal ND_O of the output circuit 110a, and a gate terminal connected to the first control signal P1, and operates in response to the first control signal P1. For example, the first transistor MP1 may perform a switching operation in response to the first control signal P1. The first transistor MP1 may be turned off when the first control signal P1 is in a first state, e.g., has the level of the gate-on voltage VON, and may be turned on when the first control signal P1 is in a second state, e.g., has the level of the ground voltage VSS. When the first transistor MP1 is turned on, the gate-on voltage VON may be outputted to the output terminal ND_O through the first transistor MP1.

The pull-down portion PDa may include a pull-down resistor R1 and a second transistor MN1 that performs a switching operation in response to the second control signal N1. The second transistor MN1 has a source terminal connected to the first gate-off voltage VOFF1, a drain terminal connected to the output terminal ND_O, and a gate terminal connected to the second control signal N1, and operates in response to the second control signal N1. For example, the second transistor MN1 may be turned on when the second control signal N1 is in a first state, e.g., has the level of the gate-on voltage VON, and may be turned off when the second control signal N1 is in a second state, e.g., has the level of the first gate-off voltage VOFF1. When the second transistor MN1 is turned on, the first gate-off voltage VOFF1 may be outputted to the output terminal ND_O through the second transistor MN1. One end of the pull-down resistor R1 may be connected to the second gate-off voltage VOFF2, and the other end of the pull-down resistor R1 may be connected to the output terminal ND_O. A resistance value of the pull-down resistor R1 may be greater than an on-resistance when the first transistor MP1 and the second transistor MN1 are turned on, and may be less than a load resistance of a gate line. Thus, when the first transistor MP1 or the second transistor MN1 is turned on, the gate-on voltage VON or the first gate-off voltage VOFF1 may be outputted to the output terminal ND_O without being influenced by the pull-down resistor R1. When both the first transistor MP1 and the second transistor MN1 are turned off, the second gate-off voltage VOFF2 may be outputted to the output terminal ND_O through the pull-down resistor R1.

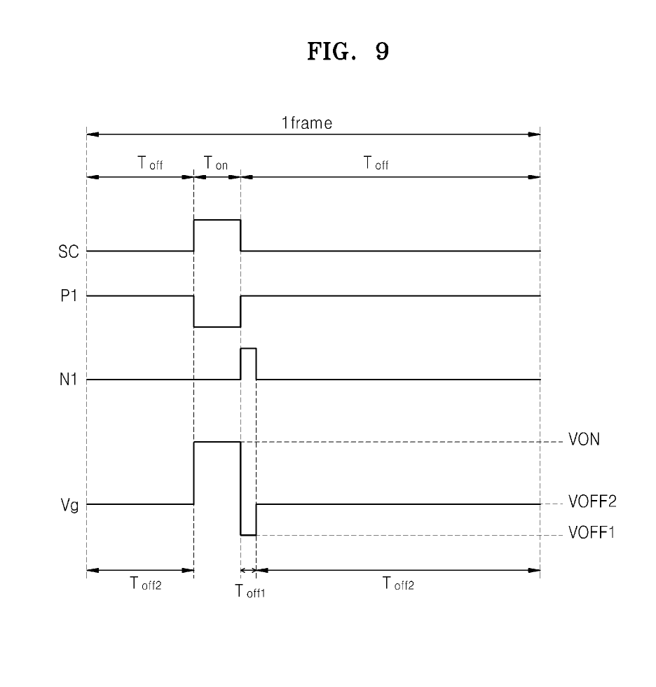

FIG. 9 is an example timing diagram illustrating an operation timing of the gate driver 100a of FIG. 8. Referring to FIG. 9, when the scan signal SC is in a first state, i.e., a gate ‘on’ period Ton, the first control signal P1 may be in a second state and the second control signal N1 may also be in the second state. Thus, the second transistor MN1 is turned off and the first transistor MP1 is turned on, and thus, the gate-on voltage VON may be outputted as the gate signal Vg. Then, when the scan signal SC is in a second state, i.e., a gate ‘off’ period Toff, the first control signal P1 may be in the first state in a desired (or alternatively, predetermined) first period Toff1 and the second control signal N1 may also be in the first state in the desired (or alternatively, predetermined) first ‘off’ period Toff1. Thus, the first transistor MP1 is turned off and the second transistor MN1 is turned on, and the first gate-off voltage VOFF1 may be outputted as the gate signal Vg. And then, in a second ‘off’ period Toff2, the first control signal P1 may be in the first state and the second control signal N1 may be in the second state. Thus, both the first transistor MP1 and the second transistor MN1 are turned off, and the second gate-off voltage VOFF2 may be outputted as the gate signal Vg through the pull-down resistor R1.

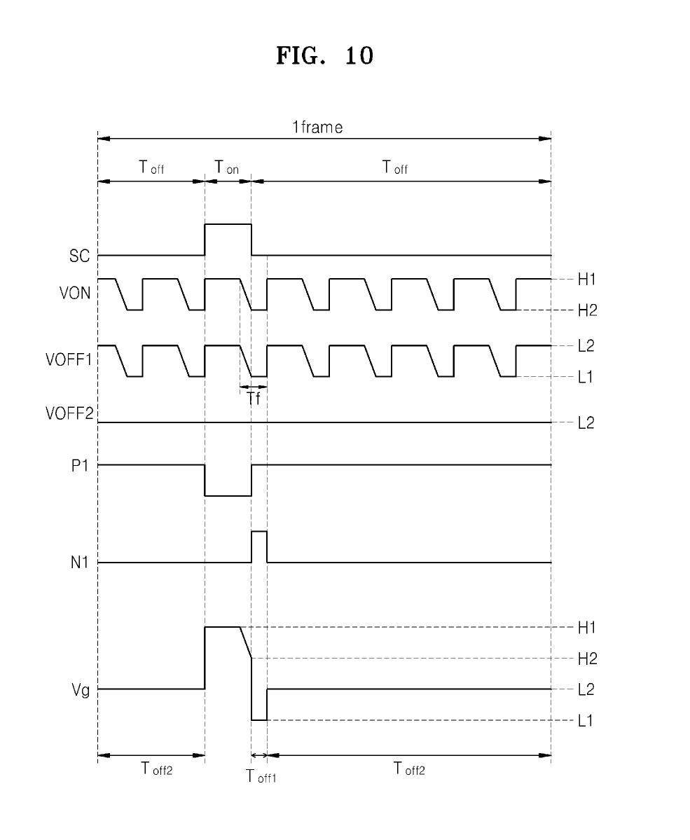

Although in the timing diagram of FIG. 9 the gate-on voltage VON, the first gate-off voltage VOFF1, and the second gate-off voltage VOFF2 each have a fixed voltage level, the inventive concepts are not limited thereto. According to at least one example embodiment of the inventive concepts, the gate-on voltage VON and the first gate-off voltage VOFF1 each may have a voltage level including a desired (or alternatively) predetermined fall period. This case is described below with reference to a timing diagram of FIG. 10.

FIG. 10 is an example timing diagram illustrating another operation timing of the gate driver 100a of FIG. 8. Referring to FIG. 10, the second gate-off voltage VOFF2 may be a voltage having a second low level L2. The gate-on voltage VON may be a voltage that is modulated to periodically have a fall period in which a voltage level thereof falls from a first high level H1 to a second high level H2. The first gate-off voltage VOFF1 may be a voltage that is modulated to periodically have a fall period in which a voltage level thereof falls from the second low level L2 to a first low level L1.

For a desired (or alternatively, predetermined) fall period Tf, the gate-on voltage VON falls from the first high level H1 to the second high level H2 and then remains at the second high level H2. The desired (or alternatively, predetermined) fall period Tf may include a portion of a gate ‘on’ period Ton. It is possible to reduce a difference between a turn-on voltage and a turn-off voltage, which are applied to a gate terminal of a TFT (e.g., the TFT of FIG. 2), by reducing the gate ‘on’ voltage VON before being changed from the gate ‘on’ period Ton to a gate ‘off’ period Toff. Thus, a kickback voltage may be reduced.

As illustrated in FIG. 10, the fall period of the gate ‘on’ voltage VON may be equal to that of the first gate-off voltage VOFF1. In addition, a voltage difference between the first high level H1 and the second high level H2 may be equal to that between the first low level L1 and the second low level L2. Thus, a voltage difference between the gate ‘on’ voltage VON and the first gate-off voltage VOFF1 may be constant. As the first gate-off voltage VOFF1 and the gate ‘on’ voltage VON fall in the same period, a voltage difference between terminals of the first transistor MP1 or second transistor MN1, for example, between the source terminal and the gate terminal, between the gate terminal and the drain terminal, or between the source terminal and the drain terminal, may be maintained within a constant rated voltage.

When the scan signal SC is in a first state, i.e., the gate ‘on’ period Ton, the first control signal P1 may be in a second state and the second control signal N1 may also be in the second state. Thus, the second transistor MN1 is turned off and the first transistor MP1 is turned on, and the gate ‘on’ voltage VON may be outputted as the gate signal Vg. In this case, as illustrated in FIG. 10, the gate ‘on’ voltage VON that is modulated from the first high level H1 to the second high level H2 may be outputted. When the scan signal SC is in a second state, i.e., a desired (or alternatively, predetermined) first period Toff1 of the gate ‘off’ period Toff, the first control signal P1 may be in the first state and the second control signal N1 may also be in the first state. Thus, the first transistor MP1 is turned off and the second transistor MN1 is turned on, and the first gate-off voltage VOFF1 may be outputted as the gate signal Vg. In the first ‘off’ period Toff1, the first gate-off voltage VOFF1 has the first low level L1. Thus, the first gate-off voltage VOFF1 having the first low level L1 may be outputted as the gate signal Vg. Then, in the second ‘off’ period Toff2, the first control signal P1 may be in the first state and the second control signal N1 may be in the second state. Thus, both the first transistor MP1 and the second transistor MN1 are turned off, and the second gate-off voltage VOFF2 having the second low level L2 may be outputted as the gate signal Vg through the pull-down resistor R1.

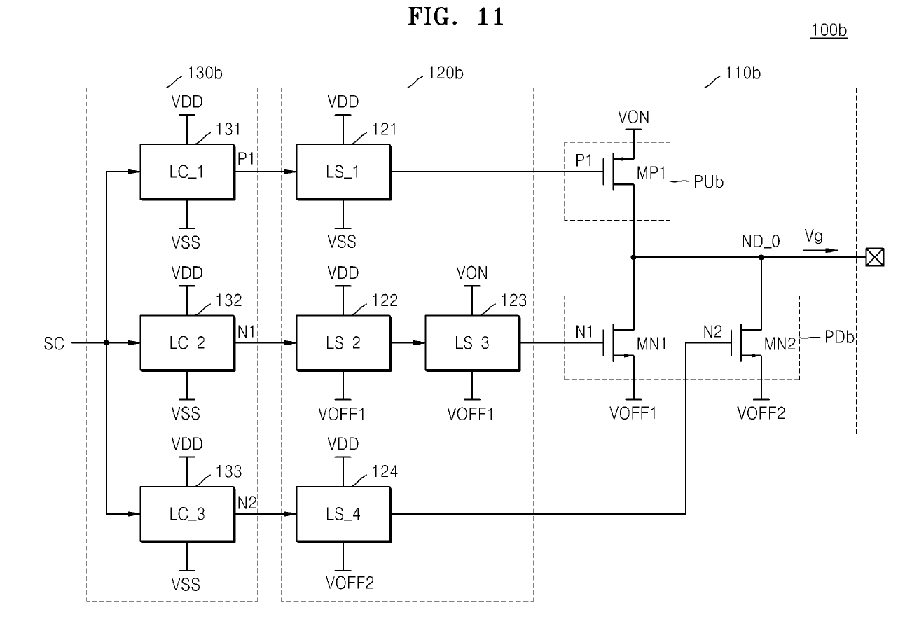

FIG. 11 is an example circuit diagram of a gate driver 100b that is another implementation of the gate driver 100 of FIG. 4. Referring to FIG. 11, a control signal generation circuit 130b may include a first logic circuit 131 that generates a first control signal P1 based on the scan signal SC, a second logic circuit 132 that generates a second control signal N1 based on the scan signal SC, and a third logic circuit 133 that generates a third control signal N2 based on the scan signal SC. The first logic circuit 131, the second logic circuit 132, and the third logic circuit 133 may receive a ground voltage VSS and a logic power supply voltage VDD to operate.

A level shift circuit 120b may include a first level shifter 121 that shifts the voltage level of the first control signal P1, second and third level shifters 122 and 123 that shift the voltage level of the second control signal N1, and a fourth level shifter 124 that shifts the voltage level of the third control signal N2. The first level shifter 121 may convert a first state (e.g., the voltage level of logic high) of the first control signal P1 to the voltage level of the gate-on voltage VON. The second level shifter 122 may convert a second state (e.g., the voltage level of logic low) of the second control signal N1 to the voltage level of the second gate-off voltage VOFF2. The third level shifter 123 may convert the first state (e.g., the voltage level of logic high) of the second control signal N1 to the voltage level of the gate-on voltage VON. The fourth level shifter 124 may convert the second state (e.g., the voltage level of logic low) of the third control signal N2 to the voltage level of the second gate-off voltage VOFF2.

An output circuit 110b may include a pull-up portion PUb that operates in response to the first control signal P1 output from the level shift circuit 120b, and a pull-down portion PDb that operates in response to the second control signal N1 and the third control signal N2. The pull-up portion PUb may include a first transistor MP1 that has a source terminal connected to the gate-on voltage VON, a drain terminal connected to an output terminal ND_O of the output circuit 110b, and a gate terminal connected to the first control signal P1, and that operates in response to the first control signal P1. The first transistor MP1 may perform a switching operation in response to the first control signal P1. The first transistor MP1 may be turned off when the first control signal P1 is in a first state, e.g., has the level of the gate-on voltage VON, and may be turned on when the first control signal P1 is in a second state, e.g., has the level of the ground voltage VSS. When the first transistor MP1 is turned on, the gate-on voltage VON may be outputted to the output terminal ND_O through the first transistor MP1.

The pull-down portion PDb may include a second transistor MN1 that performs a switching operation in response to the second control signal N1, and a third transistor MN2 that performs a switching operation in response to the third control signal N2. The second transistor MN1 has a source terminal connected to the first gate-off voltage VOFF1, a drain terminal connected to the output terminal ND_O, and a gate terminal connected to the second control signal N1, and operates in response to the second control signal N1. The second transistor MN1 may be turned on when the second control signal N1 is in a first state, e.g., has the level of the gate-on voltage VON, and may be turned off when the second control signal N1 is in a second state, e.g., has the level of the first gate-off voltage VOFF1. When the second transistor MN1 is turned on, the first gate-off voltage VOFF1 may be outputted to the output terminal ND_O through the second transistor MN1. The third transistor MN2 has a source terminal connected to the second gate-off voltage VOFF2, a drain terminal connected to the output terminal ND_O, and a gate terminal connected to the third control signal N2, and operates in response to the third control signal N2. The third transistor MN2 may be turned on when the third control signal N2 is in a first state, e.g., has the level of the ground voltage VSS, and may be turned off when the third control signal N2 is in a second state, e.g., has the level of the second gate-off voltage VOFF2. When the third transistor MN2 is turned on, the second gate-off voltage VOFF2 may be outputted to the output terminal ND_O through the third transistor MN2.

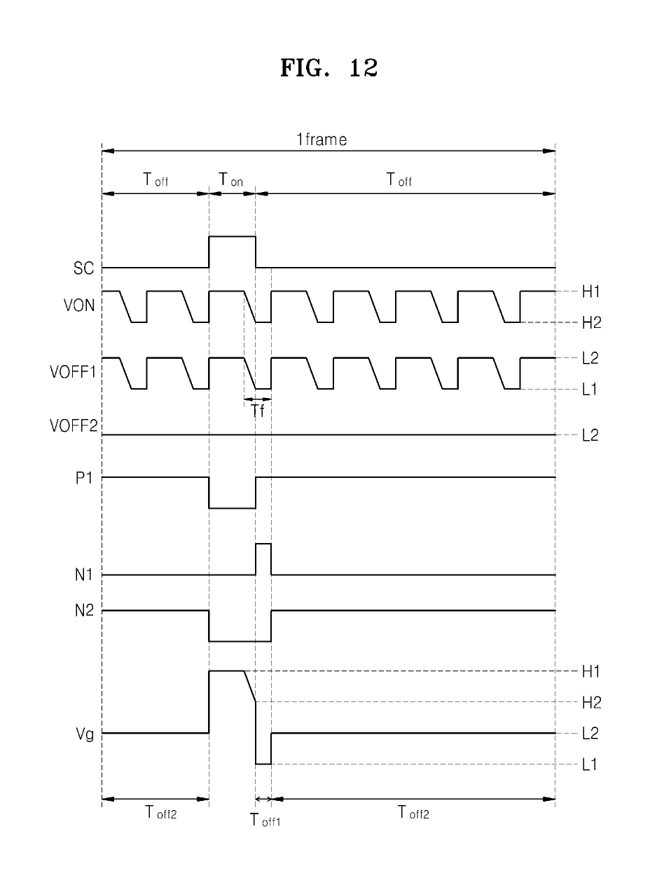

FIG. 12 is an example timing diagram of a gate driver 100b of FIG. 11. When the scan signal SC is in a first state, i.e., a gate ‘on’ period Ton, the first control signal P1 may be in a second state, the second control signal N1 may also be in the second state, and the third control signal N2 may also be in the second state. Thus, the second and third transistors MN1 and MN2 are turned off and the first transistor MP 1 is turned on, and the gate-on voltage VON may be outputted as the gate signal Vg. In this case, as illustrated in FIG. 12, a gate-on voltage VON is modulated from the first high level H1 to the second high level H2. When the scan signal SC is in a second state, i.e., a desired (or alternatively, predetermined) first ‘off’ period Toff1 of a gate ‘off’ period Toff, the first control signal P1 may be in the first state, the second control signal N1 may also be in the first state, and the third transistor MN2 may be in the second state. Thus, the first and third transistors MP1 and MN2 are turned off and the second transistor MN1 is turned on, and the first gate-off voltage VOFF1 may be outputted as the gate signal Vg. In the first period Toff1, the first gate-off voltage VOFF1 has the first low level L1. Thus, the first gate-off voltage VOFF1 having the first low level L1 may be outputted as the gate signal Vg. Then, in the second ‘off’ period Toff2, the first control signal P1 may be in the first state, the second control signal N1 may be in the second state, and the third control signal N2 may be in the first state. Thus, the first and second transistors MP1 and MN1 are turned off and the third transistor MN2 is turned on, and thus, the second gate-off voltage VOFF2 having the second low level L2 that is higher than the first low level L1 may be outputted as the gate signal Vg.

Although the gate-on voltage VON and the first gate-off voltage VOFF1 are shown as periodic voltages modulated to periodically have a desired (or alternatively, predetermined) fall period as illustrated in FIG. 12, the gate-on voltage VON and the first gate-off voltage VOFF1 may be constant voltages. Also in this case, the first through third control signals P1, N1, and N2 may be the same as those illustrated in FIG. 12, and the gate signal Vg may also be the same as that illustrated in FIG. 12.

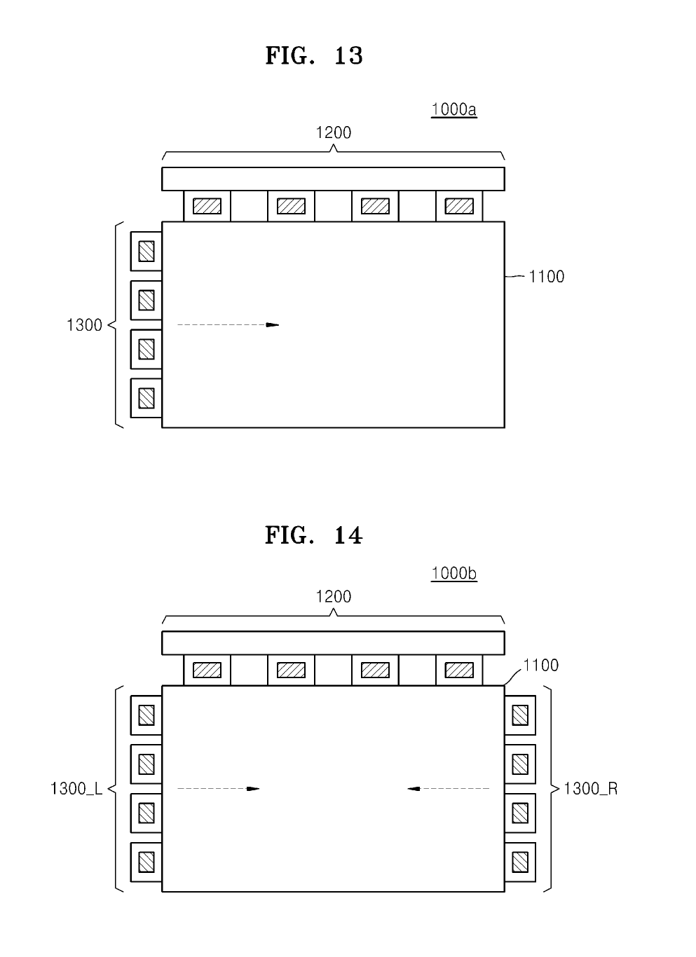

FIG. 13 is an example diagram of a display device 1000a that is an implementation of the display device 1000 of FIG. 1. Referring to FIG. 13, the display device 1000a may include a display panel 1100, and a source driver 1200 and a gate driver 1300, which are electrically connected to the display pane 1100. Although FIG. 13 shows that the source driver 1200 includes four sub-source drivers and the gate driver 1300 includes four sub-gate drivers, the inventive concepts are not limited thereto. The number of sub-source drivers may vary according to the resolution of the display panel 1100 and the number of source lines which each sub-source driver drives, and the number of sub-gate drivers may vary according to the resolution of the display panel 1100 and the number of gate lines which each sub-gate driver drives.

The source driver 1200 may include only a single sub-source driver, the gate driver 1300 may include only a single sub-gate driver, and the source driver 1200 and the gate driver 1300 may be integrated in a single chip.

The source driver 1200 is electrically connected to the upper portion or lower portion of the display panel 1100, and may transmit data signals in a column direction of the display panel 1100 through data lines.

The gate driver 1300 is electrically connected to the left side or right side of the display panel 1100, and may transmit gate signals in a row direction of the display panel 1100 through gate lines. As a panel size of the display panel 1100 increases, a load to be driven by the gate driver 1300 also increases. In addition, as a frame frequency and a resolution increase, one horizontal period decreases. According to at least one example embodiment of the inventive concepts, the gate driver 1300 may reduce a fall time of a gate voltage and reduce a difference between a fall time of a gate voltage on a left side point of a gate line and a fall time of a gate voltage on a right side point of the gate line when the gate line is changed from a gate ‘on’ state to a gate ‘off’ state, and as such, may increase a time where data is charged in one horizontal period.

FIG. 14 is an example diagram of a display device 1000b that is another implementation of the display device 1000 of FIG. 1. Referring to FIG. 14, the display device 1000b may include a display panel 1100, and a source driver 1200 and two gate drivers 1300_L and 1300_R, which are electrically connected to the display panel 1100. The display device 1000b of FIG. 14 is similar to the display device 1000a of FIG. 13. However, in the display device 1000b, the gate driver 1300_L may be electrically connected to the left side of the display panel 1100 and the gate driver 1300_R may be electrically connected to the right side of the display panel 1100. In the display device 1000b, a load to be driven by each of the gate drivers 1300_L and 1300_R is reduced since the same gate signal is applied from the left and right sides of the display panel 110 by both of the gate drivers 1300_L and 1300_R. Thus, a fall time of a gate voltage of a gate line and a difference between fall times of gate voltages at various points of the gate line may be reduced.

The display device 1000a of FIG. 13 and the display device 1000b of FIG. 14 may increase a data charging time in one horizontal period by reducing a fall time of a gate voltage of a gate line and a difference between fall times of gate voltages at various points of the gate line. Thus, the display device 1000a and the display device 1000b may be efficiently used in a large television or an electronic device that should form a picture having a high frame frequency and high resolution, such as a three-dimensional image. However, the inventive concepts are not limited thereto and the display device 1000a and the display device 1000b may also be used in image devices such as a tablet personal computer, a mobile phone, a monitor, and the like.

While the inventive concepts have been particularly shown and described with reference to exemplary embodiments thereof, it will be understood that various changes in form and details may be made therein without departing from the spirit and scope of the following claims.

What is claimed is:

1. A gate driver for driving gate lines of a display panel, the gate driver comprising:
a scan signal generator configured to generate a scan signal for selecting one of the gate lines; and
an output circuit configured to,
receive a gate-on voltage, a first gate-off voltage, and a second gate-off voltage, the gate-on voltage being a voltage that turns on at least one switching device connected to the selected gate line, the first gate-off voltage and the second gate-off voltage being voltages that turn off the at least one switching device connected to the selected gate line,
output the gate-on voltage to the selected gate line in response to a first state of the scan signal, and
sequentially output the first gate-off voltage and the second gate-off voltage to the selected gate line in response to a second state of the scan signal.

2. The gate driver of claim 1, wherein the output circuit is configured to,
output the gate-on voltage in a gate ‘on’ period of the scan signal,
output the first gate-off voltage in a first period of a gate ‘off’ period of the scan signal, and
output the second gate-off voltage in a second period of the gate ‘off’ period after the first period.

3. The gate driver of claim 1, wherein the first gate-off voltage is a voltage modulated to periodically fall from a first low level equal to a voltage level of the second gate-off voltage to a second low level less than the first low level.

4. The gate driver of claim 3, wherein the gate-on voltage is a voltage modulated to periodically fall from a first high level to a second high level, a fall period of the first gate-off voltage being equal to a fall period of the gate-on voltage.

5. The gate driver of claim 4, wherein a difference between a voltage level of the gate-on voltage and a voltage level of the first gate-off voltage is constant.

6. The gate driver of claim 1, wherein the first gate-off voltage has a first low level that is constant, and the second gate-off voltage has a second low level that is constant and greater than the first low level.

7. The gate driver of claim 1, wherein the output circuit comprises:
a pull-up portion connected to the gate-on voltage and configured to output the gate-on voltage to an output terminal if the scan signal is in the first state; and
a pull-down portion connected to the first gate-off voltage and the second gate-off voltage and configured to sequentially output the first gate-off voltage and the second gate-off voltage to the output terminal if the scan signal is in the second state.

8. The gate driver of claim 7, further comprising:
a control signal generator configured to generate a plurality of control signals based on the scan signal, the plurality of control signals controlling the output circuit.

9. The gate driver of claim 8, wherein the pull-down portion comprises:
a transistor having a source terminal connected to the first gate-off voltage, a drain terminal connected to the output terminal, and a gate terminal connected to a control signal, the transistor being configured to perform a switching operation in response to the control signal to output the first gate-off voltage; and
a pull-down resistor connected between the second gate-off voltage and the output terminal.

10. The gate driver of claim 8, wherein the pull-down portion comprises:
a first transistor having a source terminal connected to the first gate-off voltage, a drain terminal connected to the output terminal, and a gate terminal connected to a first control signal, the first transistor being configured to perform a switching operation in response to the first control signal to output the first gate-off voltage; and
a second transistor having a source terminal connected to the second gate-off voltage, a drain terminal connected to the output terminal, and a gate terminal connected to a second control signal, the second transistor being configured to perform a switching operation in response to the second control signal to output the second gate-off voltage.

11. The gate driver of claim 1, wherein the gate driver drives ‘n’ number of gate lines and the scan signal generator generates ‘n’ number of scan signals, wherein ‘n’ is a natural number.

12. A display driver circuit, comprising:
a voltage generator configured to generate a plurality of power supply voltages by using an external power supply;
a source driver configured to apply data signals to a display panel; and
a gate driver configured to
receive a gate-on voltage, a first gate-off voltage, and a second gate-off voltage from the voltage generator, the gate-on voltage being a voltage that turns on at least one transistor connected to the selected gate line, the first gate-off voltage and the second gate-off voltage being voltages that turn off the at least one transistor connected to the selected gate line, and
sequentially output the gate-on voltage, the first gate-off voltage, and the second gate-off voltage as a gate signal based on a scan signal of a corresponding gate line.

13. The display driver circuit of claim 12, wherein the gate driver is configured to,
output the gate-on voltage in a gate ‘on’ period,
output the first gate-off voltage in a first period of a gate ‘off’ period, and
output the second gate-off voltage in a second period of the gate ‘off’ period after the first period.

14. The display driver circuit of claim 13, wherein in the first period, a voltage level of the first gate-off voltage is less than a voltage level of the second gate-off voltage.

15. The display driver circuit of claim 12, wherein the gate driver is connected to both sides of the display panel.

16. A gate driver for a display panel, the gate driver comprising:
a scan signal generator configured to generate at least one scan signal for selecting at least one gate line of the display panel; and
at least one output circuit configured to sequentially output at least first, second, and third voltages to the selected at least one gate line based on the at least one scan signal, the first voltage being greater than the second and third voltages, the second voltage being less than the third voltage.

17. The gate driver of claim 16, wherein,
the first voltage corresponds to a gate ‘on’ voltage, and
the second and third voltages correspond to first and second gate ‘off’ voltages, respectively, the gate ‘on’ voltage being a voltage that turns on at least one switching device connected to the selected at least one gate line, the first gate ‘off’ voltage and the second gate ‘off’ voltage being voltages that turn off the at least one switching device connected to the selected at least one gate line.

18. The gate driver of claim 17, wherein an output duration of the second voltage is less than an output duration of the third voltage.

19. The gate driver of claim 16, wherein the at least one output circuit includes,
a pull-up circuit configured to output the first voltage to the selected at least one gate line if the at least one scan signal has a first state, and
a pull-down circuit configured to sequentially output the second and third voltages to the selected at least one gate line if the at least one scan signal switches from the first state to a second state.

20. The gate driver of claim 16, wherein,
the first voltage is a modulated voltage that periodically has a fall period in which the first voltage falls from a first high level to a second high level,
the second voltage is a modulated voltage that periodically has a fall period in which the second voltage falls from a first low level to a second low level, and
the third voltage is a constant voltage.
